(19) United States
(12) Patent Application Publication
(10) Pub. No.: US 2007/0218836 A1
(43) Pub. Date: Sep. 20, 2007

(54) Mounting apparatus for wireless communication module

(75) Inventors: Lin-Yun Hong, Shenzhen (CN); Hsuan-Chen Chen, Tu-Cheng (TW); Chien-Li Tsai, Tu-Cheng (TW); Chun-Chi Liang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,872

(22) Filed: Oct. 16, 2006

(30) Foreign Application Priority Data
Mar. 16, 2006 (CN) 200620056733.8

(51) Int. Cl. H04B 7/00

(52) U.S. Cl. 455/41.2

(57) ABSTRACT

A mounting apparatus for mounting a wireless communication module to a computer component is provided. The wireless communication module comprises two flanges. The mounting apparatus comprises a bottom plate, two side plates, and two locking blocks inwardly formed on the two side plates respectively, to engage with the flanges of the wireless communication module. The mounting apparatus is detachably attached on the computer component via an adhesive.

### 1. FIELD OF THE INVENTION

The present invention relates to mounting apparatuses for wireless communication modules, and particularly to a mounting apparatus for readily mounting a wireless communication module to a computer component.

### 2. DESCRIPTION OF RELATED ART

Various kinds of wireless communication facilities or devices have been developed and are widely used today, and comprise such as portable computers, mobile phones, wireless network access devices, wireless network communicating devices or cards, etc., for allowing people to communicate with each other easily and quickly.

In the field of personal computers, there are various wireless communication protocols, one of which is named blue tooth. Typically, a personal computer is equipped with a blue tooth module. The blue tooth module is mounted to the computer with screws. However, installation and removal of the blue tooth module requires a tool such as a screwdriver. This makes the process unduly cumbersome and complicated. In addition, special screw holes have to be drilled in an electronic computer component that the blue tooth module is to be mounted on. Such an electronic computer component is usually a motherboard. Forming a hole in the motherboard not only occupies precious space of the motherboard, but may damage the motherboard.

What is needed is a mounting apparatus for readily mounting a wireless communication module to a computer component.

### SUMMARY OF THE INVENTION

An exemplary mounting apparatus for mounting a wireless communication module to a computer component is provided. The wireless communication module comprises two flanges. The mounting apparatus comprises a bottom plate, two side plates, and two locking blocks inwardly formed on the two side plates respectively, to engage with the flanges of the wireless communication module. The mounting apparatus is attached on the computer component.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a mounting apparatus in accordance with a preferred embodiment of the present invention, with a blue tooth module and a motherboard; and

FIG. 2 is an assembled view of FIG. 1.

### DETAILED DESCRIPTION OF THE INVENTION

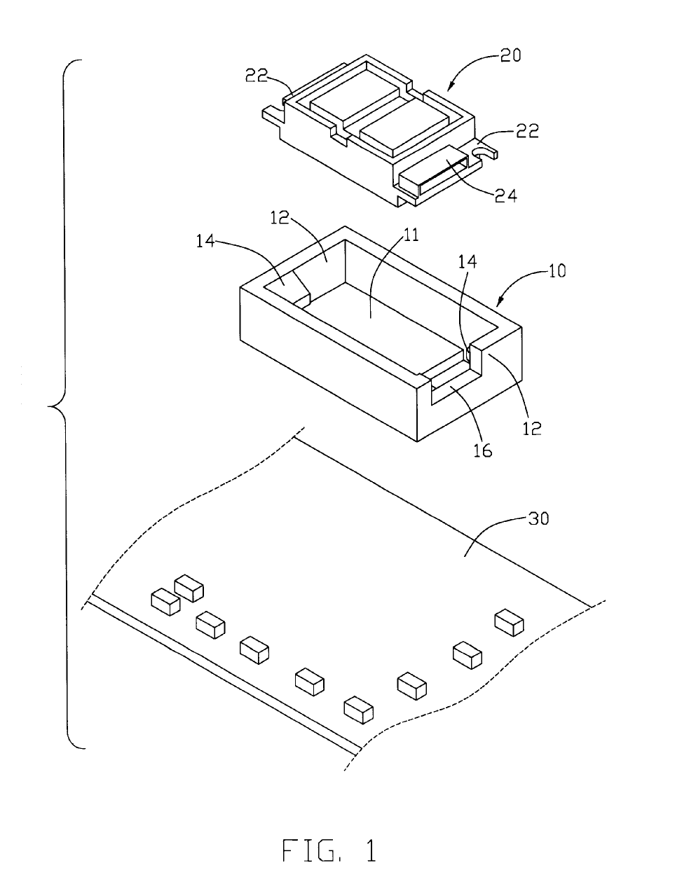

Referring to FIG. 1, a mounting apparatus 10 in accordance with a preferred embodiment of the present invention is provided to mount a wireless communication device to a computer component. In this embodiment, the wireless communication device is a blue tooth module 20, and the computer component is a motherboard 30.

The blue tooth module 20 is generally box-shaped, with two opposite ends thereof extending out to form two flanges 22. A connector interface 24 is formed on one of the flanges 22. A flexible cable (not shown) connects the connector interface 24 to the motherboard 30.

The mounting apparatus 10 is made of plastic, and generally box-shaped corresponding to the blue tooth module 20. The mounting apparatus 10 includes a bottom plate 11, and four side plates 12 extending up from four edges of the bottom plate 11, cooperatively defining a receiving space therebetween. Two opposite side plates 12 form two wedge-shaped locking blocks 14 inward respectively, with a top surface of each locking block 14 being a slanting surface. One of the side plates 12 defines a cutout 16 therein corresponding to the connector interface 24 of the blue tooth module 20, for extension of the flexible cable therethrough.

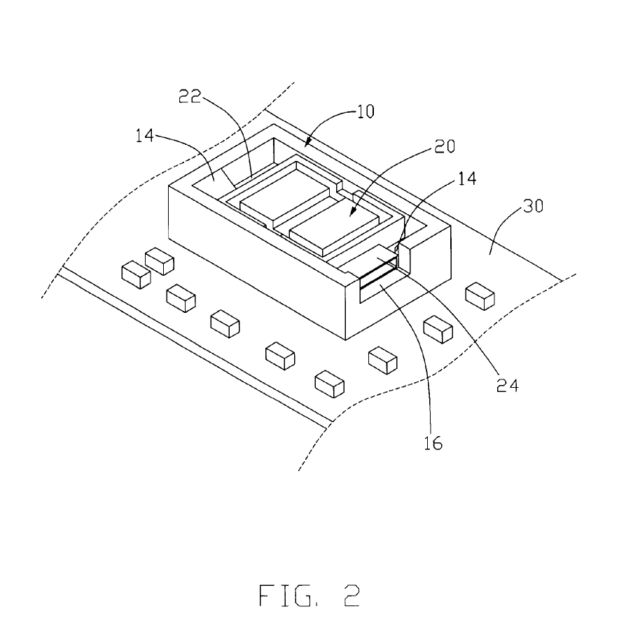

Referring also to FIG. 2, in assembly, the blue tooth module 20 is pressed in the receiving space of the mounting apparatus 10, with the flanges 22 passing over the slanting surfaces of the locking blocks 14, and snappingly engaging under the flanges 22. Thus, the blue tooth module 20 is fixed in the mounting apparatus 10. Then, the mounting apparatus 10 combined with the blue tooth module 20 is attached to the motherboard 30 via an adhesive such as glue. Preferably, the bottom plate 11 of the mounting apparatus 10 is coated with glue in advance, and covered with a protective paper to be torn away when time to attach the mounting apparatus 10 to the motherboard 30.

Because the mounting apparatus 10 is made of plastic, it is somewhat flexible to engagingly receive the blue tooth module 20. It is also easy to deform the mounting apparatus 10 to disengage the locking blocks 14 from the flanges 22 of the blue teeth module 20 when removing the blue tooth module 20 from the mounting apparatus 10. Glue on the bottom plate 11 of the mounting apparatus 10 can readily and quickly adhere the mounting apparatus 10 on any suitable place of the motherboard 30, thereby avoiding drilling special screw holes in the motherboard 30.

The foregoing description of the exemplary embodiment of the invention has been presented only for the purposes of illustration and description and is not intended to be exhaustive or to limit the invention to the precise forms disclosed. Many modifications and variations are possible in light of the above teaching. The embodiment was chosen and described in order to explain the principles of the invention and its practical application to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. A mounting apparatus for mounting a wireless communication module to a computer component, the wireless communication module comprising two flanges, the mounting apparatus comprising a bottom plate, two side plates, and two locking blocks inwardly formed on the two side plates respectively, to engage with the flanges of the wireless communication module, the mounting apparatus being attached on the computer component.

2. The mounting apparatus as claimed in claim 1, wherein the mounting apparatus is made of plastic so as to flexibly engagingly receive the wireless communication module.

3. The mounting apparatus as claimed in claim 1, wherein the bottom plate of the mounting apparatus is coated with adhesive.

4. The mounting apparatus as claimed in claim 1, wherein another two side plates together with the two side plates extend up from four edges of the bottom plate of the mounting apparatus to cooperatively define a receiving space therebetween, the wireless communication module detachably received within the receiving space.

5. The mounting apparatus as claimed in claim 1, wherein each of the locking blocks is wedge-shaped, with a top surface thereof being a slanting surface.

6. The mounting apparatus as claimed in claim 1, wherein one of the at least two side plates defines a cutout therein for extension of a flexible cable of the wireless communication module therethrough.

7. The mounting apparatus as claimed in claim 1, wherein the wireless communication module comprises a blue tooth module, and the computer component comprises a motherboard.

8. A wireless communication module mounting apparatus arranged on a computer component, the mounting apparatus being made of flexible plastic and defining a receiving space engagingly receiving a wireless communication module therein.

9. The wireless communication module mounting apparatus as claimed in claim 8, wherein the computer component comprises a motherboard, the mounting apparatus is attached to any suitable place of the motherboard via an adhesive.

10. The wireless communication module mounting apparatus as claimed in claim 9, wherein the adhesive comprises a glue with a removable protective paper thereon.

11. The wireless communication module mounting apparatus as claimed in claim 8, wherein the wireless communication module comprises a blue tooth module having two flanges at opposite ends thereof.

12. The wireless communication module mounting apparatus as claimed in claim 11, comprising a bottom plate and a plurality of side plates extending up from the bottom plate, wherein a locking block is formed inward on each of two of the side plates to engage with the flanges of the blue tooth module.

13. The wireless communication module mounting apparatus as claimed in claim 12, wherein a connector interface is formed on one of the flanges, one of the side plates of the mounting apparatus defines a cutout therein corresponding to the connector interface.

14. A mounting apparatus mounting a wireless communication module to a motherboard, the wireless communication module comprising two flanges, the mounting apparatus comprising a bottom plate, a plurality of side plates extending from the bottom plate and cooperating with the bottom plate to form a space configured for receiving the wireless communication module therein, and two locking blocks inwardly extending from the side plates, wherein the wireless communication module is capable of sliding over the locking blocks to cause the flanges thereof to snapply engage with the locking blocks to thereby hold the wireless communication module in the space, and the mounting apparatus is detachably attached on the motherboard via an adhesive.

15. The mounting apparatus as claimed in claim 14, wherein the mounting apparatus is deformable to allow the locking blocks to disengage from the flanges of the wireless communication module.

16. The mounting apparatus as claimed in claim 14, wherein the wireless communication module comprises a connector interface, and one of the side plates of the mounting apparatus defines a cutout configured for exposing the connector interface to outside of the mounting apparatus.
